(19) United States
(12) Patent Application Publication
(10) Pub. No.: US 2022/0389171 A1
(43) Pub. Date: Dec. 8, 2022

(54) LIGNOCELLULOSIC COMPOSITE FORMED BY A FIRST SOURCE FROM MAIZE PLANT WASTE WITH CELLULOSE FIBRES FROM A SECOND SOURCE AND PRODUCTION METHOD

(71) Applicant: growPack Bio LLC, Middleton, DE (US)

(72) Inventors: Sofia Zavalla PORTA, Guanacaste (CR); Sean Cristian TENORIO, Buenos Aires (AR); Exequiel Wenceslao JUSTO BUNGE BERG, Campinas (BR)

(21) Appl. No.: 17/773,906

(22) PCT Filed: Nov. 8, 2019
(86) PCT No.: PCT/IB2019/059636

§ 371 Date: May 3, 2022

(51) Int. Cl. C08H 8/00

(52) U.S. Cl. CPC C08H 8/00

(57) ABSTRACT

Lignocellulosic composite formed by a mix of fibers coming from a first source of maize harvest waste and the procedure to obtain it, which consists of at least part of the stalk and leaves (husk) in a proportion by weight of 65% to 90% of the total fiber weight, mixed with 35% to 10% of the total weight of fibers from a second source based on annual plant species waste, with a width, lumen and thickness lower than those of the fiber from the first source. The first source of fibers have a high cationic charge, the fibers and fines produced being contained in a paste by the mechanical process of the maize coming from a first source of fibers with the fibers with a stronger tensile coming from the second source of fibers, forming self-linkages, establishing hydrogen-bridge bonds providing for fibers union interaction with fibers with greater mechanic strength of the second source of fibers.

### FIELD OF THE INVENTION

The main purpose of this invention is a novel lignocellulosic composite formed by a base of maize plant waste, mixed with waste obtained from annual plant species, being its subordinate purpose a production method thereof.

### BACKGROUND AND PRIOR ART

The production process of lignocellulosic composites, such as cellulose pulp is obtained by processing wood to obtain pulp, or mixture paste. Basically, wood is made up of lignin and cellulose fibers, and the first step to obtain pulp is to grind solid wood. Depending on the processes used, two types of pulp can be distinguished:

Mechanical Pulping. Mechanical processes grind wood and release fibers. This process converts up to 95% of the wood into pulp but retains the lignin, which subsequently gives paper a brownish or yellowish tint.

Chemical Pulping. Wood is first transformed into small chips and then cooked with chemicals, followed by a refining process. Chemical extraction liberates the lignin that binds the cellulose fibers together and convert it into a final product mass.

Depending on the process and the type of wood used, both long-fiber or short-fiber pulp can be obtained.

Overall, it can be observed that the cellulose pulp industry, with or without the use of lignin, has wood shred obtained from tree plantations as its main component, which apart from having an high financial cost component, implies the cutting of trees, which if not regulated in an organized and strict manner, leads to the phenomenon of deforestation, with serious ecological implications. Tree cutting regulations require a slow process of afforestation and seedlings growth until the pertinent planted species growth level is achieved, with the consequent waiting time.

The average paper industry standard involves the use of 17 trees to manufacture one tonne of paper. This has severe cost and environmental implications. On the other hand, it is well known that the production of cellulose pulp, according to the processes known in the art, is highly pollutant because the liquid effluents are toxic to the environment. Specific treatment to reduce their toxicity is expensive, and on the other hand they are not one hundred percent effective, leaving pollution residuals accepted by current regulations, but still polluting water courses.

Obtaining cellulosic pulp from sugar cane bagasse is also known in prior art. According to prior experience in the industry, bagasse must be morphologically improved by separating as much parenchymatous tissue as possible, thus proportionally increasing fibers content. This process adds an additional cost apart from the fact that sugar cane bagasse is already considered an input and it has a specific cost as such. Bagasse fibers are classified as short fibers compared to hardwood fibers, based on their biometric parameters. For this reason, chipped bagasse mixed with rag residues or recycled paper is used, as bagasse fibers by themselves have little flexibility and can be brittle, resulting in end products of lower quality.

Sugar cane bagasse mixed with wheat stalks duly cut is also known in the industry. This mixture provides positive results, but its production is limited in financial terms based on the costs of transport logistics included in taking the stalks from the wheat-growing areas to the sugarcane harvesting mills, or the bagasse wheat area, usually located in very distant areas. In addition, not all geographical areas suitable for wheat cultivation are suitable for sugarcane cultivation, so this solution excludes large geographical areas of the planet, in which there is either no wheat harvest or no sugarcane harvest.

The industry has experimented with relative success the production of cellulose pulp from pineapple production waste mixed with recycled paper, such as the process patented by the firm Pepelyco (Colombia), but this process is limited to the areas where cellulose pulp production takes place, which are generally tropical areas and recycled paper, on the other hand, requires a process of cleaning, ink extraction, purification, etc., which entails high energy waste and a high level of environmental pollution.

Finally, and this is of particular interest for the purposes of the present invention, there is knowledge of some laboratory tests carried out in Mexico with the leaves of the sweet maize plant (tamales) by cooking them with chemical components, but no indications have been found that production has been undertaken at an industrial level. As a comparative experiment, maize leaves were treated locally in a Sprout Waldron refiner with a 0.010 inch disc opening and the resulting paste was purified in a piano purifier. First, the maize paste was refined alone in a laboratory PFI refiner, obtaining a raw material from which laboratory leaves were made, which turned out to be very weak and brittle, and being unable to perform tests due to the weakness of the leave's structure. It is noted that this type of pasta provides for a structure but is not enough to produce paper or other practical use, and this is possibly the reason for the alleged failure of the above laboratory test carried out in Mexico.

Table 1 shows comparative data of biometric typing of corn with respect to the same data of different cellulosic fibers:

| | Average | Fibre | | |
|---|---|---|---|---|
| | length | width | Lumen | Thickness |
| Species | (mm) | (μm) | (μm) | (μm) |
| Maize leaf | 1.86 | 47.4 | 32.1 | 7.5 |
| Sugar cane Bagasse | 1.50 | 20.0 | 12.0 | 4.0 |
| Eucalyptus globulus | 0.94 | 18.3 | 9.65 | 4.3 |
| Kenaf | 1.29 | 22.1 | 12.7 | 4.3 |

(The term “LUMEN” refers to the cavity formed by the cell walls after cell death).

It is observed that corn-related data show a longer fibre, with twice the width and lumen, i.e., and very thick walls, which justifies the stiffness and weakness of specimens in the final product, explains the reasons why this is not used to manufacture cellulose pulp, and its subsequent transformation into final products (paper, cardboard, molded products, etc.) based on the high fragility of the final products obtained.

### OBSTACLES FOUND IN PRIOR ART

Taking for granted the above concepts illustrating the disadvantages derived from the use of trees to obtain cellulosic paste; also the great majority of the known processes for the production of cellulosic paste use a high amount of energy, and use chemical products whose effluents pollute the environment, particularly waterways (rivers, seas, etc.)

If trees are not used to obtain cellulosic paste, raw materials usually used consist of sugar cane bagasse, which mean two disadvantages from the logistics and the raw material supply point of view.

The corn husk tamal (leaves) of the maize plant is not used because of the aforementioned fragility of the final product and therefore in the threshing of the corn, the stalk and leaves are considered as waste to be disposed of, generally by burning, with the consequent environmental pollution, or it is integrated into animal feed, but with a very low energy component.

Energy costs and environmental pollution, already mentioned, shall be added to these disadvantages, since they are caused by processes with aggressive chemical products.

Finally, relatively long and broad fibers of the corn husk (tamal) create a series of problems in the drainage of the processing tanks, since the drainage of the fluids is slowed down and complicated by the caking of the fibers, creating blockages.

### FIELD OF THE INVENTION

The first aim of the present invention is to achieve a lignocellulosic composite from non-wood fibrous material coming from agricultural waste of little or no commercial value.

This invention also aims to eliminate the stages of removal, disposal and elimination of non-wood fibrous materials coming from agricultural and forestry waste and to use them in the production of the lignocellulosic composite according to the present invention, eliminating a cost factor that to date creates a disadvantage that adds a cost to farm production, and on the contrary, giving added value to this agricultural waste.

This invention also aims to substitute wood fibrous materials as raw material for the manufacture of the lignocellulosic composite, so it is possible to reduce deforestation, enhance environmental protection or prevent its deterioration.

This invention also aims that maize paste from a first source of fibre based on maize waste is mechanically treated by mixing it with at least fibers coming from waste of a second source of fibre of annual vegetable species, provided that these second fibers have a width, lumen and thickness smaller than that of the first source of fibre of annual vegetable species, provided that these second fibers have a width, lumen and thickness smaller than that of the first source of fibre of annual vegetable species, which allows a stronger binding of the paste, and providing for the structure of paper, cardboard and cellulosic molded products with adequate flexibility, acceptable bursting and tearing values, higher than those of a product of the same type based on each of the first and second plant species considered as single raw material (i.e., not combined as proposed by the present invention) and for the same purposes.

A secondary aim of the present invention is to set a procedure to obtain the composition of said cellulosic paste, including a sequence of mechanical procedural steps without the use of environmentally polluting chemicals.

### SUMMARY OF THE INVENTION

LIGNOCELLULOSIC COMPOSITE FORMED BY A FIRST SOURCE FROM MAIZE PLANT WASTE WITH CELLULOSE FIBERS FROM A SECOND SOURCE,

whereas the composite is comprised of mixtures of long and wide fibers from a first source of maize harvest waste which consists of at least part of the stalk and leaves (husk) in a proportion by weight of 65% to 90% of the total weight, mixed with 35% to 10% of the total weight of fibers from a second source based on annual plant species waste, with a width, lumen and thickness lower than those of the fibre from the first source; said first source of fibers having a high cationic charge, the fibers and fines produced being contained in a paste by the mechanical process of the maize coming from a first source of fibers with the fibers with a stronger tensile coming from the second source of fibers.

A secondary object of the invention is to set the procedure to obtain said cellulosic pulp, consisting of performing the following stages in succession:
a) shred (chipear) a mixture of husk and cane of the maize plant, (hereinafter waste of the first source of fibers) until reducing the set in pieces of an average length of 3 to 5 cm and diameter between 1 to 3 cm;
b) submerge the mass of waste from the first source of shredded fibers in a pan with an aqueous liquid, the same being chosen between drinking water or water with a solution of HONa, preferably at 10% by volume of water and a temperature ranging from room temperature to 90° C. and for a lapse of time ranging from 30 to 70 minutes;
c) put into the pan the fibers from the second source of fibers with a cut length range from 2 to 4 cm, in 65 to 90% proportion of maize fibre and 35% to 10% of second fibers, agitating for a lapse of time ranging from 30 to 60 minutes, and with a range of temperature between room temperature and 60° C., segregating all the fibers from both fibre sources and mixing them;
d) put into the pan, the mixture of fibers in a refiner with water at 5% by weight of the total weight of the fibers, so that between the fibers there are reciprocal anchoring centers, creating a series of portions of fibre mesh, keeping the fibers in suspension under agitation;
e) put the wet mixture into a cyclonic purification device, recovering the mix of fibers;
f) put a cationic agent with a high cationic charge and a flocculating agent into the pan, and remove the water from the bottom of the agitator;
g) remove the mass of water up to a volume of remaining water ranging from 0.15 to 0.5% of weight of fibre mass.

### BRIEF DESCRIPTION OF THE DRAWINGS

FIG. 1 shows in a schematic way a block diagram illustrating the production cycle of the lignocellulosic composite from maize plant waste, according to the present invention.

FIG. 2 illustrates an electron microscope magnification of a sample of fibers, basal elements and husk fine maize based on the first source of fibers.

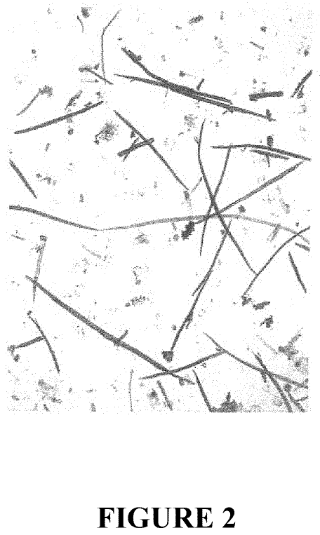

FIG. 3 illustrates a magnification of a cotton fibre (optical microscope) being the second source of fibers.

FIG. 4 illustrates an electron microscope magnification of the bonding of cotton fibers containing corn fibers and the fine maize resulting from obtaining mechanical corn paste.

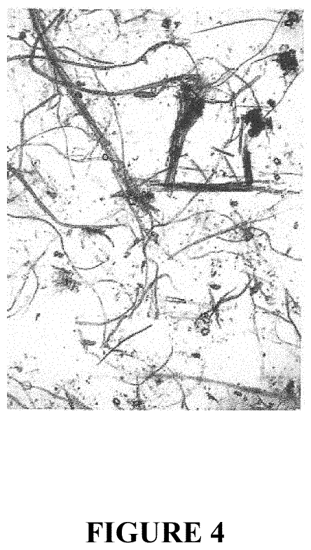

FIG. 5 illustrates various drain rate curves employing various flocculant-coagulant compounds, justifying the use of the preferred flocculant-coagulant for the present invention.

### PREFERRED EMBODIMENT OF THIS DESCRIPTION

For the purposes of exemplifying the preferred embodiments of this description, a diagram of cellulose pulp production is attached, supported by the description of said process given below, and embodiments and examples of realization should be interpreted as one of the many possible embodiments of the invention, so that no limiting value should be assigned to them, including within the scope of protection of the invention the possible means equivalent to those illustrated; the scope of the present invention being the invention determined by the first claim stated in the corresponding Claims section.

Considering the morphology of the fibre of the maize plant, it is subdivided into the category long fibre, with an average length of 1.86 mm, an average length of 1.86 mm, an average width of 47.4 μm, an average lumen of 32.1 μm and an average thickness of 7.5 μm. These characteristics make it a very strong tensile fibre.

According to the present invention, the first source of fibers is obtained from the chipping and subsequent defibrillation of corn stalks and leaves, resulting in long fibers and short (fine) fibers.

This first source of fibers has two specific functions in the pulp: first, its provides for volume and mass, and second, since the seeds have starch, they help in the formation and smoothness process, a characteristic feature of this cellulosic paste.

According to this invention, the mechanically treated corn paste is mixed with at least one second source of fibers. These preferred second sources of fibers are obtained from linter and long cotton fibers, but this invention also contemplates the combination of the first source of fibers (maize) with one or more annual vegetable fibers as a second source of fibers chosen, among others, from:
cotton waste,
miscanthus,
canamo,
sugar cane,
sorghum,
ppanicum, etc.

Secondary fibers are characterized by having a similar average length, but a smaller width, lumen and thickness than the maize fibre, which allows for a stronger paste bond but a greater flexibility achieved due to the thickness and width of these secondary fibers.

The maize leaf has a fibrous outer layer that provides most of the cellulosic fibre and an inner medulla consisting mainly of vascular bundles that transport liquids inside the plant; and this medulla provides the characteristics of opacity in paper. The internal part of the maize plant consists of a medullary mass composed mainly of cellular tissue, free from sap and other impurities; and this material provides for a pure source of natural cellulose. Basic bio-compounds that make up this type of plant material are cellulose, hemicellulose and lignin, all in different proportions according to the plant genus and variety.

Table 2 shows the chemical composition of the maize leaf compared to sugar cane:

| | | Sugarcane | Sugarcane |
|---|---|---|---|
| | Corn Leaf | Bagasse | Bagasse |
| Compound | % Dry base | % Dry base | % Dry base |
| Holocellulose | 78.86 | 73.24 | 59 to 76 |
| a-cellulose | 43.14 | 41.67 | 32 to 44 |
| Lignin | 23.00 | 19.98 | 19 to 24 |
| Ashes | 0.761 | 1.30 | 1.5 to 5.0 |

It is observed that the cellulose and lignin content is higher in corn waste.

Table 3 compares quality indices of maize fibers and sugar cane bagasse in respect to other fibers:

Quality indices of maize-leaf fibers and sugar cane
bagasse fibers compared to other fibre-based material

| | | | | Pulp Quality |
|---|---|---|---|---|
| | | Tensile | | Classification |
| | Runkel | Strength | Flexibility | bases on |
| Type of Fibers | ratio | Coefficient | Coefficient | Runkel ratio |
| Corn Leaf | | | | |
| Zea mays | 0.466 | 0.316 | 0.677 | Very Good |
| Sugarcane Bagasse | | | | |
| Saccharum officinarum L. | 0.660 | 0.400 | 0.600 | Good |
| Eucalyptus globulus* | 0.895 | 0.472 | 0.527 | Good |
| Eucalyptus dunnii* | 0.686 | 0.407 | 0.592 | Good |
| Jacaranda acutifolia** | 0.400 | 0.280 | 0.710 | Very Good |
| Tila mexicana** | 0.400 | 0.280 | 0.710 | Very Good |
| Bellotia mexicana** | 0.510 | 0.340 | 0.650 | Good |
| Clethra mexicana** | 0.660 | 0.340 | 0.600 | Good |

*Values obtained for these species by Sanjuan (1997),
**Values obtained for these species by Tamarit (1996).

In order to obtain pulp from long-fibers, the process of removing the medulla from the bark, as performed in the sugar cane industry, is not considered since the medulla has a positive effect on the final product texture, by lightning and softening the leaf, contributing up to 20% of the cellulosic material.

As mentioned above, the biomass of the lignocellulosic composite, exclusively composed of fibers from maize plant waste, has not given satisfactory results in the final products obtained therefrom, which resulted in brittle, fragile products with little or no flexibility.

Surprisingly, it was determined that when fibers from the first source of fibers (maize waste) are combined with fibers from a second source of fibers chosen among a variety of vegetable species waste, preferably cotton crop waste, a lignocellulosic composite is obtained in which these fibers from a second source interact with the maize fibers and provide for the mechanical tensile strength and the flexibility needed for paper, cardboard or paperboard structure, or provides for obtaining molded products with their pertinent tensile strength and flexibility. Preferred waste for the second source of fibers, without limitation to the present invention, come from cotton ginning. Cotton waste (fibril) are residues of the fibre used for cotton spinning, and to date, that waste has no commercial value or use whatsoever.

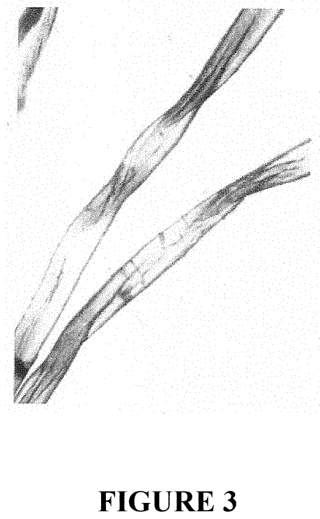

The fibril of the second source of fibers (cotton) is a ribbed fibre (see FIG. 3) and the linter has a more cylinder-like structure. Either fibre needs to be cut and refined for further use. It is worth mentioning that the linter is a fibre already used in the manufacture of paper money, while the fibril is not suitable for the paper industry due to its structure, and its use in this industry is an absolute novelty. In summary, the main novelty of the present invention from the point of view of the composition of the lignocellulosic composite consists in interweaving fibers from two sources of vegetable fibers of different nature, preferably maize waste fibers with other waste fibers coming from cotton ginning, in the proportions already described herein.

This novel lignocellulosic composite is the result of the mix of two types of fibers that are not traditionally used in the manufacture of paper products or useful to make cellulosic molded products.

The use of these two fibers resulted in a compact structure with the necessary strength to produce products with acceptable tensile strength. A series of specimens consisting of paper laminates were made with this lignocellulosic composite.

The combination of the present invention benefits the interaction of the bonds between a fibre with high tensile strength (cotton fibril) and the particularity of the corn fibre with its own characteristics providing foe mass and compactness favoring voluminous structures such as those needed for the walls of a cellulose-walled container.

Cotton fibers originate around cotton seeds. Its 3 to 4-lobed capsules open at maturity, each lobe contains 5 to 10 seeds and each seed is covered by a large number of fibers, from 10,000 to 20,000 fibers per seed.

Cotton seeds' fibers are epidermal outgrowths epidermal excrescences or trichomes, therefore, they do not present lignification and cannot be considered as true fibers despite the use of this term. These hairs have the shape of a flattened tube and have a structure consisting of a cuticle composed of a mixture of cutin and pectin, an outer layer of cellulose, a layer of secondary deposits almost entirely composed of cellulose, walls surrounding the central spiral-shaped cavity filled with a nitrogenous substance. The chemical composition of cotton fibre is 94% cellulose, 1.23% proteins, 1.2% pectins, 1.2% minerals, 0.6% waxes, 0.3% sugars, and other components.

Considering cotton as a second source of fibers, cotton waste used is characterized by its ribbed shape, high flexibility and tensile strength. This fibre comes from cotton production waste, which has no advantageous use in the industry today. Its large surface area makes it suitable for blending with any type of fibre, especially those producing fines. This is due to their large specific surface area which can exert a very strong combination through hydrogen-bridge bonds with other fibers.

Structures that generate fines, such as maize, are efficiently retained by the same effect. Cotton fibers bind and entangle fibers and fines produced in the mechanical maize paste.

### Process to Obtain Paste of This Invention

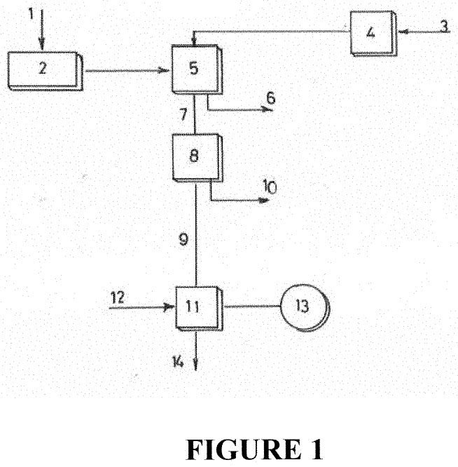

In respect to the process to obtain paste of this invention, within the stages mentioned above and the previous chapter “Summary of the invention”, and according to the block diagram in FIG. 1, corn husk waste comprising the whole plant (leaf and cane) were processed. They were treated in a Sprout Waldron refiner with a disc opening of 0.010 inches and the resulting lignocellulosic composite was purified in a piano purifier. As a reference element, corn paste alone was refined in a laboratory PFI refiner, resulting in raw material used to make laboratory sheets which turned out to be very weak and brittle and could not be tested due to the structural weakness of the specimens. As mentioned before, it is noted that this type of pulp just made from corn fibers, provides for a structure but does not give sufficient properties to generate paper. The various equipment used in the procedure of the invention are illustrated below.

The initial corn pulp was blended with cotton pulp previously cut and refined in a Valley refiner to a Schopper-Riegler (SR) of 20/30° . The study consisted in the combination of 80% corn fibers and 20% cotton fibers and it showed good physicochemical properties. This filling is now suitable for the production of the lignocellulosic composite.

As previously mentioned, one of the main obstacles in cellulosic pulp production from maize plant fibers and which the present invention has been able to solve with full satisfaction, after numerous laboratory tests, is the slow drainage of liquids from tanks or reactors. In effect, the length and width of the corn waste fibers form a plug at the outlet of the liquids that blocks the outlet, making drainage a painfully slow operation that requires mechanical agitation, with the consequent consumption of energy. Based on the fact that corn fibers are highly cationic, it has been found through a series of studies based on coagulants and flocculants with the idea of being able to form floccules that allow water drainage according to the speed and needs of efficient treatment, both from the energetic point of view and from costs and operative time issues.

### Flocculation/Coagulation Study

Drainage speed tests were carried out on a filling of cotton pulp and mechanical corn husk pulp. The aim was to increase the drainage of the filling by dosing coagulants and a specific additive. The results obtained in the tests carried out lead us to the following comments:
It is possible to decrease the drainage time up to almost 90%, increasing drainage speed by dosing an anionic trash catcher-coagulant (ATC) with a high cationic charge and a drainage agent (polyacrylamide flocculant);
The almost null turbidity of the water drained during the tests indicates that fines retention is very high; and this will be reflected in the plant by generating a low-solid content effluent with a lower consumption of fibrous material per ton of product;
The optimization both additives doses must be carried out through an in-house testing;
The dose for this filling is relatively high compared to a kraft pulp paper filling. The need for a high dosage of ATC indicates a high cationic demand of the filling.

Drainage speed tests were carried out on a filling of cotton pulp and mechanical corn husk pulp. The sample was received at 10% consistency. The sample was diluted to 1% dispersion and the drainage tests were performed in Schopper-Riegler equipment. Since there was no history of this type of filling and due to the very low drainage, SR>60° , preliminary tests were carried out. Different coagulants and diluted drainage agents were tested.

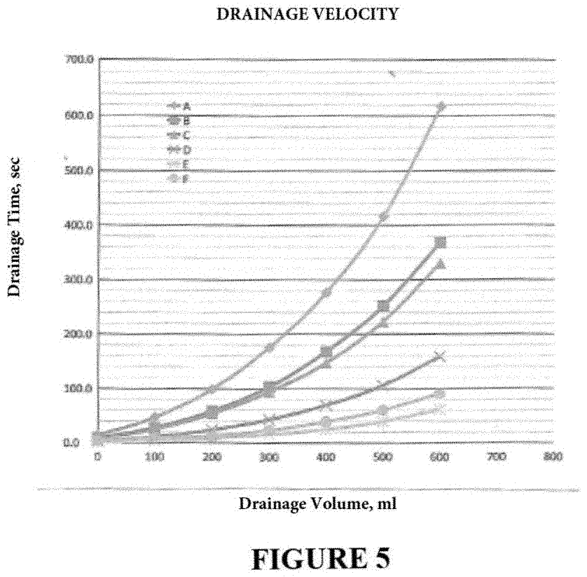

Tests that did not show a reduction in the draining time were discarded. FIG. 5 shows the large increase in drainage speed gained with our LV-8111 ATC-coagulant and our LV-SF BH flocculant (Tests E and F). Other results are shown for comparison purposes only. Water drained in test A showed some turbidity, a property that decreased in the different tests as it was gradually possible to increase drainage speed, especially in the water drained in test E, where turbidity was almost non-existent. These results show that the combination of ATC and a draining agent not only contributes to increase drainage but also to high retention. The latter shall be verified in plant by generating an effluent with low amounts of suspended solids and a lower specific consumption of fibrous material.

Relatively high dosages of coagulants and flocculants, when compared to dosages used in papermaking based on kraft pulps, is due to the presence of a comparatively (with that type of pulp) high amount of fines and what is known as anionic trash (colloids). This is normal in high-yield pulps such as the mechanical corn husk pulp, which also has the particularity of coming from annual plant species.

Table 4 summarizes the results obtained.

TABLE 4

| | | | | | | |
|---|---|---|---|---|---|---|
| Coagulant | 8111 | 8111 | 8111 | 8111 | 8111 | 8111 |
| Dose, kg/tn | 0 | 0 | 2 | 2 | 2 | 3 |
| Flocculant | — | AFAH | AFAH | SF B1 | SFBH | SFBH |
| Dose, kg/tn | | 2.0 | 1.6 | 2.5 | 1.5 | 0.9 |
| Volume/Test | A, | B, | C, | D, | E, | F, |
| | sec. | sec | sec | sec. | sec. | sec. |
| 0 | 0 | 0 | 0 | 0 | 0 | 0 |
| 100 | 14.3 | 8.6 | 8.0 | 3.5 | 1.3 | 4.1 |
| 200 | 46.2 | 27.8 | 25.0 | 11.0 | 3.8 | 10.0 |
| 300 | 98.8 | 58.0 | 53.3 | 24.1 | 8.6 | 12.5 |
| 400 | 175.4 | 103.2 | 93.9 | 42.6 | 15.7 | 22.9 |
| 500 | 276.1 | 167.8 | 147.0 | 69.1 | 25.1 | 38.8 |
| 600 | 415.8 | 251.8 | 223.3 | 105.8 | 39.4 | 59.9 |
| 700 | 617.1 | 369.0 | 330.5 | 159.0 | 61.3 | 91.1 |

The filling without additives showed a result of ° SR 60 while the addition of the additives reduced drainability to ° SR 20. This is a marked improvement drainage speed and formation.

From the above, we can conclude the following:
A drainage speed suitable for the subsequent process was achieved.
High fibre retention can be achieved and fines can be used for such processes.
A high dosage of the retention and drainage system was obtained, however, they are not excessively high when compared to those required for high performance pulps.

The husk and part of the corn stalk were obtained from agricultural production waste, which consider these components as residues with no major commercial value, with high volumes per season.

Added to this, cotton fibril is obtained, which is nowadays considered waste in cotton production processes as it does not meet the quality standards for the pharmaceutical/hospital and textile industries. This fibril is obtained after repeated carding of cotton and is discarded at the side of the machine. Nowadays it does not have a major commercial value.

In the tests carried out, the percentages of raw material to be used in each production batch is 80% corn and 20% cotton (or secondary fibers), which are weighed and deposited in a continuous flow of machines:

Chopping Machine: Once the clean corn stalks are received, they are cut lengthwise into two or four halves (depending on the stalks' thickness), which can vary from 1 to 3 cm in diameter), to then cut them transversely into pieces of approximately 2 cm long, in order to obtain long-fibre pulp. As already mentioned, removing the medulla from the bark, a procedure commonly performed in the sugar industry, is not considered in this case since the medulla positively affects the final product texture, by lightening and softening the leaf.

The same pan or reactor was then heated with the same components with a temperature range of 50 to 90° C. per time lapse of 30 to 70 minutes, and an improved cellulose pulp was obtained, but with a reduction of up to 50% by weight of the initial mass of chipped components.

Tomato Pulper PVF: The raw materials are introduced by means of a conveyor belt. The purpose of this machine is to be able to cut the fibers down to reach the length needed. The parts of the mechanism in contact with the paste (rotor, crown, platen, pulp chamber and tank) are made of stainless steel 304. The parts of the mechanism, pulper legs, protections and pulleys are made in painted carbon steel.

DV Cyclonic Debugger: Once the fibers have reached the expected length a pump is opened so that the paste passes through a purifier. The purpose is to purify the paste, removing heavy materials (soil, sand, etc.). The body is made of stainless steel 304 and the rejection box is made of cast iron.

VF refiner: After the lignocellulosic composite has already been purified, it is passed through a pump to the refiner to refine said composite, i.e. to separate corn fibers from cotton fibers (secondary fibers) so when it comes to the formation stage, they are free from each other and may have the highest percentage of free surface for contact with other fibers. This is possible thanks to refining discs. The refining time or r.p.m. is a fundamental factor for the refining of the lignocellulosic composite. The refining disc is made of stainless steel in the contact parts and coated carbon steel in the parts that do not have contact with the paste. The refiner is equipped with a 75 Hp@1800 rpm motor.

Tank with VF agitator: When the lignocellulosic composite achieves proper refining and 25° SR, it goes through the agitation tanks, which function is to keep the composite in motion and in suspension so that it does not settle to the bottom. A series of tanks are used, which work jointly to bring the composite to the expected dilution, e.g. 0.3% dilution for making parts for molds; 4% dilution for stocking, and 2% dilution for paper making. Once the pulp reaches the corresponding dilution, this dilution is transferred by means of a pump to the machine to be used. The tanks are made of stainless steel with carbon steel legs with paint coating.

Agitator: The agitator shall be made of stainless steel in the parts in contact with the composite and carbon steel with paint coating. The agitator shall have a motor of Hp20@900 rpm.

### Procedural Tests and Tests on Specimens

Physical tests of Filling. With this filling, sheets specimens with a grammage of 140 g/m2, similar to three paper samples used commercially in the manufacture of paper for making corrugated cardboard were made. Tests were carried out with the specimens (sheets of paper) with grammage: 140 g/m2 and a thickness of 250 μm, with the following results:

### Crop/Cotton 80/20 Tests Results:

140 g/m2*and a thickness of 250 μm

| RCT | CMT | SCT | Bursting |
|---|---|---|---|
| KN/m | N/10 waves | KN/m | KPa |
| 1.65 | 286 | 3.34 | 409 |

### Reference Samples (Recycled Paper) (M1 M2 M3)

Grammage: 135 g/m2

| RCT | | | CMT | | | SCT | | |
|---|---|---|---|---|---|---|---|---|
| KN/m | | | N/10 waves | | | KN/m | | |
| M1 | M2 | M3 | M1 | M2 | M3 | M1 | M2 | M3 |
| 1.37 | 1.36 | 1.42 | 415 | 405 | 370 | 2.95 | 2.83 | 2.89 |

CMT tensile strength: CMT tensile strength is a key characteristic of corrugating paper. CMT expresses the piano crush resistance of ten channels of a given corrugation type, made from paper sample. As for corrugated cardboard, the corrugation is made in the longitudinal direction of the paper.

RCT measurement: This measurement indicates the resistance of the paper when subject to compressive force, distributed and exerted on the thickness of a ring-shaped sample of a given circumference (152.4 mm). The RCT increases with paper weight, and is not recommended for paper grammage lower than 150.

SCT measurement: This measurement represents the compressive strength in the transverse direction of the paper between two grips separated by a distance of 0.7 mm. This short distance allows to suppress the influence of the deformation of the sample, and to take into account only the characteristics of the fibers and the related bonds or joints between them. (ISO Standard No. 9895). RCT, CMT and SCT tests are used to categorize the properties of paper used in the manufacture of liner and wave paper.

### BRIEF SUMMARY

The results obtained show how compatible the elements are and puts into evidence that the formulation described in this invention is useful to obtain paper with proper tensile strength.

Based on their high cellulose content (a-cellulose+hemicellulose), and compared to other sources of fibers, corn leaves are an optimal raw material to manufacture mechanical cellulose pulp, which makes it possible to take advantage of the agricultural corn waste in the area. The biometric study of corn husk fibers shows that they are a fibrous material with good properties of tensile strength in respect to beating. They also have a wide lumen, thus increasing their capacity for impregnation with chemical reagents in the pulping process properly mixed with fibrous material, the maize leaf is an optimal raw material for the production of special paper. The characteristics of its morphology give the paper made thereof a volumetric content, while long-fibre annual vegetal species provides for its tensile strength.

In the cellulosic composite of the invention a plurality of self-bonds are formed, providing for hydrogen bonds, benefiting the interaction of high tensile strength fiber bonds (cotton) and having the particularity of corn fibre with its ease of body and compactness, thus favoring bulky structures such as those required by the walls of cellulose-walled containers.

1-LIGNOCELLULOSIC COMPOSITE FORMED BY A FIRST SOURCE FROM MAIZE PLANT WASTE WITH CELLULOSE FIBRES FROM A SECOND SOURCE, whereas the composite is formed by mixtures of fibers from a first source of maize waste fibre which consists of at least part of the stalk and leaves (husk) in a proportion by weight of 65 to 90% of the total weight of fibre, mixed with 35 to 10% of the total weight of a second source of fibres from the waste of a plant species, with a width, lumen and thickness less than those of the fibre from the first source; The first source of fibres has a high cationic charge, the fibres and fines produced being contained in a matrix maize-based paste with mechanical properties with fibres having greater tensile strength, which come from the second source of fibres, forming self-linkages, establishing hydrogen-bridge bonds providing for fibres union interaction with fibres with greater mechanic strength of the second source of fibres, which source is the fibres from the first source of fibres are waste of maize fibres in its major proportion long and wide and the fibres with an average length of 3 to 5 ems and diameter between 1 to 3 ems waste; and the second source of fibres being waste of one or more vegetal species selected from any of the following: cotton waste; Miscanthus; hemp; bagasse (sugar cane); mala hoja (sugarcane cane leaf) sorghum and panicum cut with a length range between to 2 to 4 ems.

2-LIGNOCELLULOSIC COMPOSITE of claim 1, whereas the fibres from cotton waste come from cotton ginning, composed by fibril and cotton seed fibres.

3-PROCEDURE TO OBTAIN THE LIGNOCELLULOSIC COMPOSITE of claims 1 and 2, whereas it includes the execution of the following stages, in succession:
a) shred (chipear) a mixture of husk and cane of the corn plant, (waste of the first source of fibres) until reducing the set in pieces of an average length of 3 to 5 ems and diameter between 1 to 3 ems;
b) submerge the mass of waste from the first source of shredded fibres in a pan with an aqueous liquid, at a temperature ranging from room temperature to 90° C. and for a large time ranging from 30 to 70 minutes;
c) put into the pan, a proportion of 65 to 90% of corn fibre and 35% to 10% of fibres from the second source, agitating for a lapse of time ranging from 30 to 60 minutes, and with a range of temperature between room temperature and 60° C., segregating all the fibres from both fibre sources and mixing them;
d) put into the pan, the mixture of fibres in a refiner with water at 5% by weight of the total weight of the fibres, so that between the fibres there are reciprocal anchoring centers, creating a series of portions of fibre mesh, keeping the fibres in suspension under agitation;
e) introduce the wet mixture into a cyclonic purification device,
f) put into the pan an anionic cationic agent with a high cationic charge and a flocculating agent, and remove the water from the bottom of the agitator;
g) remove the mass of water up to a volume of remaining water ranging from 0.15 to 0.5% of weight of fibre mass.

4-PROCEDURE TO OBTAIN THE LIGNOCELLULOSIC COMPOSITE of Claim 3, whereas the LV-8111 ATC-coagulant is used and the LV-SF BH is used as flocculant.

5. PROCEDURE TO OBTAIN THE LIGNOCELLULOSIC COMPOSITE of claim 3, whereas aqueous liquid is chosen between drinking water or water with a solution of HONa at 10% by volume of water.
